(19) United States
(12) Patent Application Publication
(10) Pub. No.: US 2016/0189179 A1
(43) Pub. Date: Jun. 30, 2016

(54) RECRUITMENT OF CONSUMERS FOR ONLINE MARKET RESEARCH INTERVIEWS

(71) Applicant: Discuss.io, Inc., Seattle, WA (US)

(72) Inventor: Zach Altmix Simmons, Seattle, WA (US)

(21) Appl. No.: 14/986,397

(22) Filed: Dec. 31, 2015

Related U.S. Application Data
(60) Provisional application No. 62/098,486, filed on Dec. 31, 2014.

(51) Int. Cl. G06Q 30/02; G06Q 50/00

(52) U.S. Cl. CPC G06Q 30/0203; G06Q 50/01

(57) ABSTRACT

A method includes receiving from a product supplier a consumer profile comprising preferred criteria, identifying recruits fitting the profile, establishing a virtual meeting space for electronic communication with said recruits, receiving from the supplier a set of questions, receiving from the recruits via the meeting space a set of answers to the questions, and supplying the answer set to the supplier.

### PRIORITY CLAIM

This patent application claims priority from U.S. Provisional App. No. 62/098,486 filed Dec. 31, 2014 and entitled “AGGREGATING ONLINE RECRUITS FOR LIVE WEBCAM INTERVIEWS,” the entirety of which is hereby incorporated by reference as if fully set forth herein.

### BRIEF DESCRIPTION OF THE DRAWING

Preferred and alternative embodiments of the present invention are described in detail below with reference to the following drawing figures:

FIG. 1 is a schematic view of elements of an embodiment of the invention;

FIG. 2 is a flowchart illustrating a recruitment process according to an embodiment of the invention;

FIG. 3 is a diagram illustrating establishment of a virtual meeting room according to an embodiment of the invention;

FIG. 4 is a diagram illustrating establishment of a user interface according to an embodiment of the invention;

FIG. 5 is a diagram illustrating a video-editing process according to an embodiment of the invention;

FIG. 6 is a schematic view of an exemplary operating environment in which an embodiment of the invention can be implemented; and

FIG. 7 is a functional block diagram of an exemplary operating environment in which an embodiment of the invention can be implemented.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Additionally, the entity that may implement, or otherwise provide the ability to implement, elements of embodiments of the invention may be referred to herein as an “administrator.”

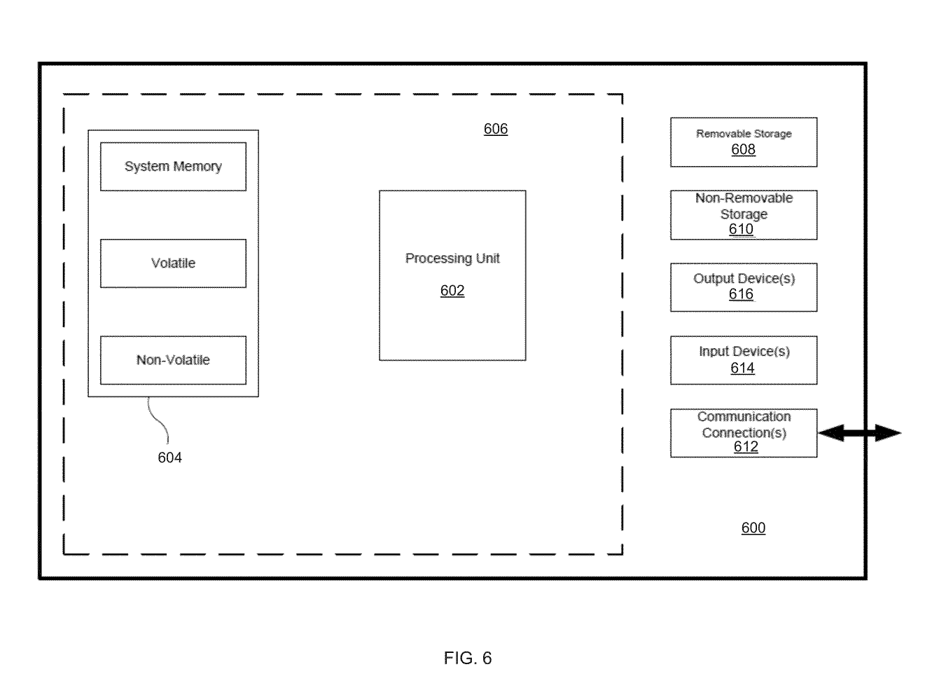

With reference to FIG. 6, an exemplary system for implementing an embodiment of the invention includes a computing device, such as computing device 600. The computing device 600 typically includes at least one processing unit 602 and memory 604.

Depending on the exact configuration and type of computing device, memory 604 may be volatile (such as random-access memory (RAM)), nonvolatile (such as read-only memory (ROM), flash memory, etc.) or some combination of the two. This most basic configuration is illustrated in FIG. 6 by dashed line 606.

Additionally, the device 600 may have additional features, aspects, and functionality. For example, the device 600 may include additional storage (removable and/or non-removable) which may take the form of, but is not limited to, magnetic or optical disks or tapes. Such additional storage is illustrated in FIG. 6 by removable storage 608 and non-removable storage 610. Computer storage media includes volatile and nonvolatile, removable and non-removable media implemented in any method or technology for storage of information such as computer-readable instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 600. Any such computer storage media may be part of device 600.

The device 600 may also include a communications connection 612 that allows the device to communicate with other devices. The communications connection 612 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 600 may also have an input device 614 such as keyboard, mouse, pen, voice-input device, touch-input device, etc. Further, an output device 616 such as a display, speakers, printer, etc. may also be included. Additional input devices 614 and output devices 616 may be included depending on a desired functionality of the device 600.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

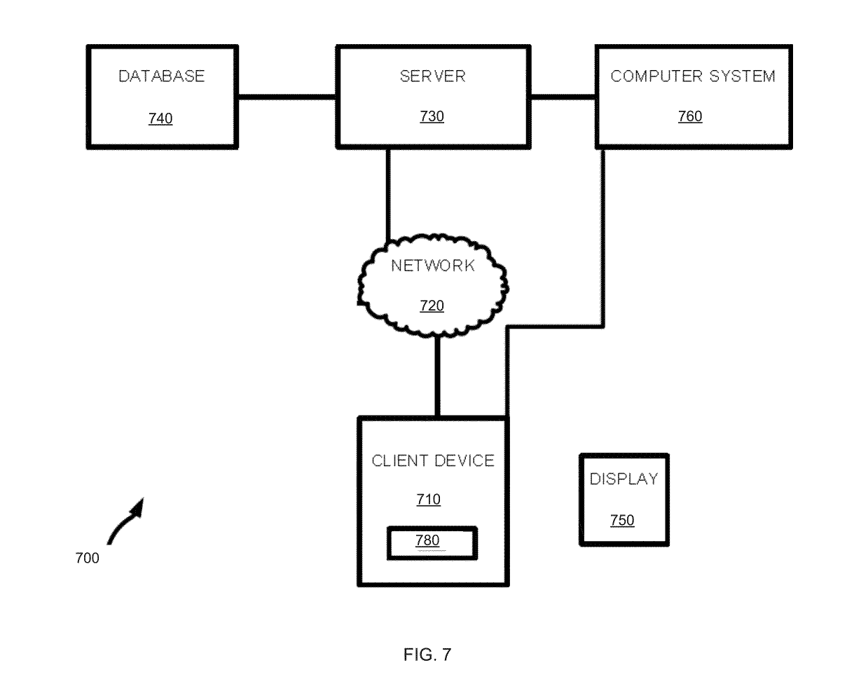

Referring now to FIG. 7, an embodiment of the present invention may take the form, and/or may be implemented using one or more elements, of an exemplary computer network system 700. The system 700 includes an electronic client device 710, such as a personal computer or workstation, tablet, smart phone or other handheld electronic device, that is linked via a communication medium, such as a network 720 (e.g., the Internet), to an electronic device or system, such as a server 730. The server 730 may further be coupled, or otherwise have access, to a database 740 and a computer system 760. Although the embodiment illustrated in FIG. 7 includes one server 730 coupled to one client device 710 via the network 720, it should be recognized that embodiments of the invention may be implemented using one or more such client devices coupled to one or more such servers.

The client device 710 and the server 730 may include all or fewer than all of the features associated with the device 600 illustrated in and discussed with reference to FIG. 6. The client device 710 includes or is otherwise coupled to a computer screen or display 750. The client device 710 may be used for various purposes such as network- and local-computing processes.

The client device 710 is linked via the network 720 to server 730 so that computer programs, such as, for example, a browser, running on the client device 710 can cooperate in two-way communication with server 730. The server 730 may be coupled to database 740 to retrieve information therefrom and to store information thereto. Database 740 may have stored therein data (not shown) that can be used by the server 730 and/or client device 710 to enable performance of various aspects of embodiments of the invention. Additionally, the server 730 may be coupled to the computer system 760 in a manner allowing the server to delegate certain processing functions to the computer system. In an embodiment, the client device 710 may bypass network 720 and communicate directly with computer system 760. In alternative embodiments, most or all of the functionality described herein may be implemented in a desktop application 780 that may include one or more executable modules and/or the aforementioned browser.

Still referring to FIG. 7, and in operation according to an embodiment of the invention, a user (not shown) of the client device 710 desiring to enjoy functionality described below herein may invoke the desktop application 780. Alternatively, the user may invoke a browser running on the client device 710 to access web content, which may, but need not, be served by the server 730. Specifically, by employing an appropriate uniform resource locator (URL) in a known manner, the user may navigate to or otherwise access a website hosted by the server 730 and access features provided by one or more embodiments described herein.

An embodiment provides a method for recruiting people quickly to participate in, for example, market research. It may include a composition of a number of independent software technologies. An embodiment automates the recruitment, hosting and execution of online depth interviews and focus groups.

An embodiment may include tight Integration into a video client, recruit-scheduling reminders, translation and interpretation with live interpreters, and video editing.

All operations described below may be performed in the context of a currently selected project. It should be noted that one can have multiple projects within his/her account.

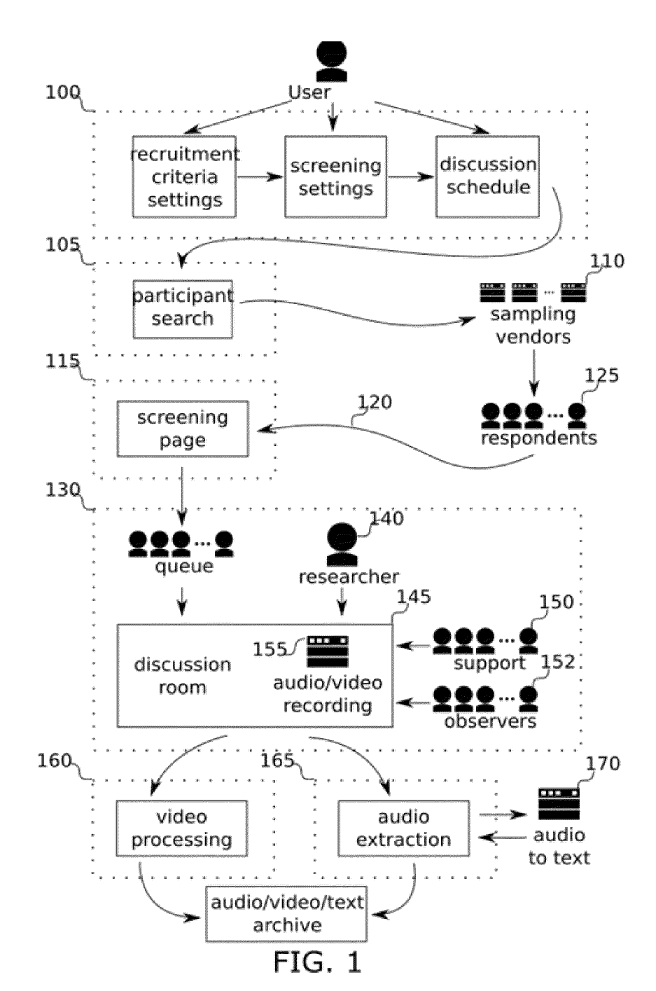

FIG. 1 illustrates a process according to an embodiment of the invention. The process of FIG. 1 may be implementable in an electronic interface to recruit human subjects for a marketing research data collection and analysis of qualitative market research data. The process of FIG. 1 is illustrated as a set of operations shown as discrete blocks. The process of FIG. 1 may be implemented in any suitable hardware (such as, e.g., server 730 and/or computer system 760), software, and/or human capital or combination thereof. The order in which the operations are described is not to be necessarily construed as a limitation.

The following discussion is with reference to FIG. 1 and the reference numerals illustrated therein.

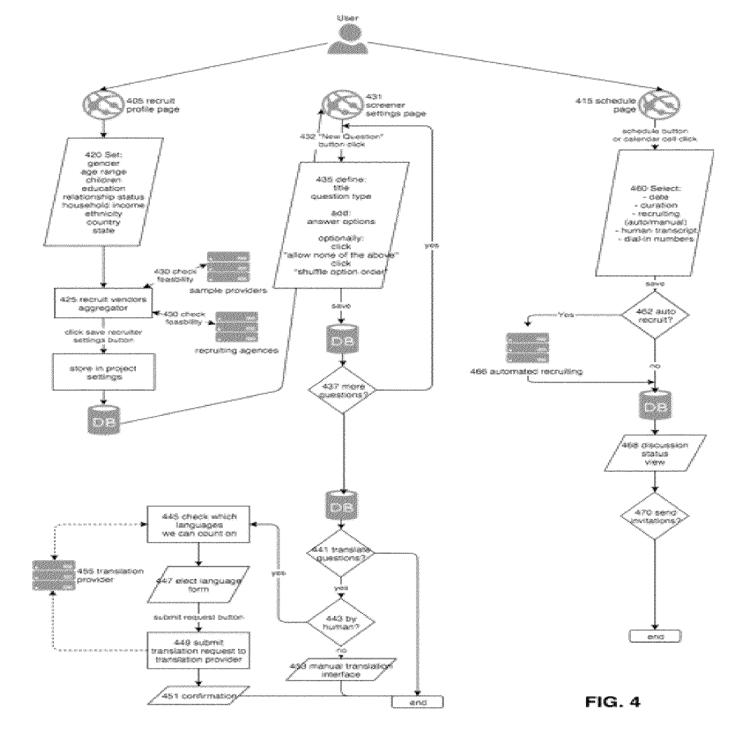

At block 100, recruitment criteria settings characterizing human subjects are formulated or otherwise established. This is described in more detail in FIG. 4.

At block 105 recruitment vendors are asked for available (and fulfilling-all-criteria) respondents. More on this is discussed with reference to FIG. 4 (as recruit vendors aggregator).

At block 110 a set of vendors is identified that provide sampling services from which panelists can be taken.

At block 115, potential recruits are informed about the nature of study. Recruits may be required to go through a screening process (if screening questions were set at block 100) and pass a client-device hardware requirements check page.

Block 125 a set of respondents that comes from recruiting vendors is identified.

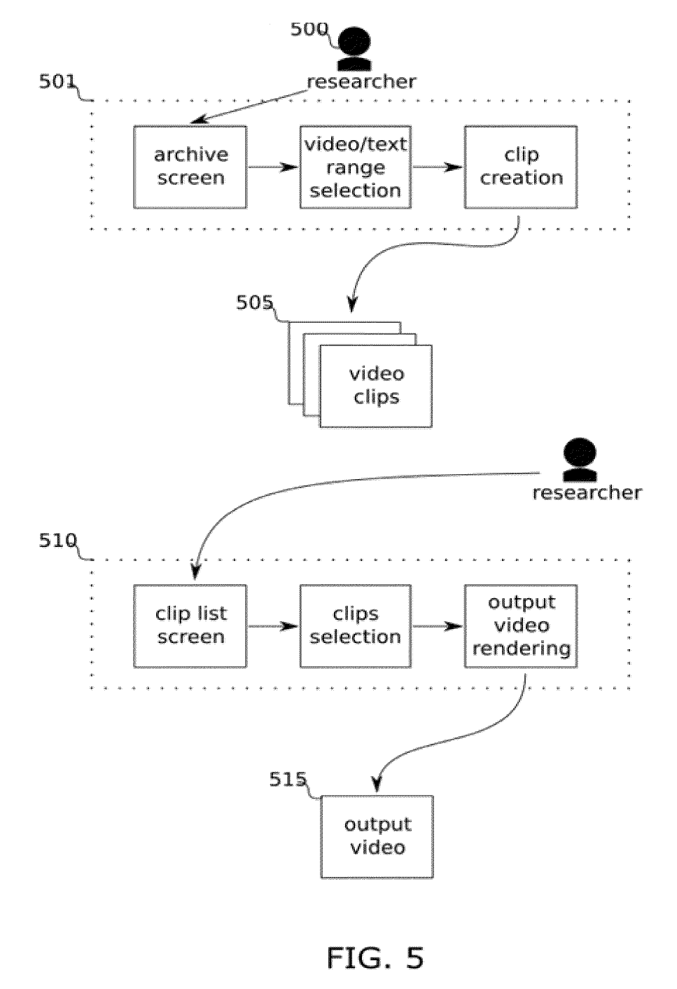

Block 130 represents the process around executing a synchronous online market research interview. This block 130 is described in more detail on FIG. 5

Block 140 represents a researcher user.

Block 145 represents a virtual meeting room.

Block 150 depicts an optional way in which the support personnel can enter this meeting room. Support personnel are granted access rights to administer the meeting room.

Block 152 depicts the ability for observers to observe the activities conducted in the meeting room while not being detected by at least some of the participants as doing so. This may be considered as, for example, the virtual equivalent of a one-way mirror in a traditional focus group facility. The recruits are unable to see or hear the observer but the observer is able to see the other participants.

Block 155 represents a service that is responsible for synchronous recording of audio, video, and/or slides of all discussion participants. This recorded data may be used in and/or to create a discussion archive.

At block 160, Video/audio processing may be performed after the discussion in order to prepare high-quality archive files. File format and video resolution may be changed in this step.

At block 165, Audio may be extracted and sent to a transcription vendor. Such vendor may employ either machine or human transcription. The choice of which may depend on what was selected on discussion schedule screen at block 100.

At block 170, an audio to text service vendor, such as an external company that is able to transcribe speech to text, may be utilized. Text is optionally advantageous for search functionality on the archive page.

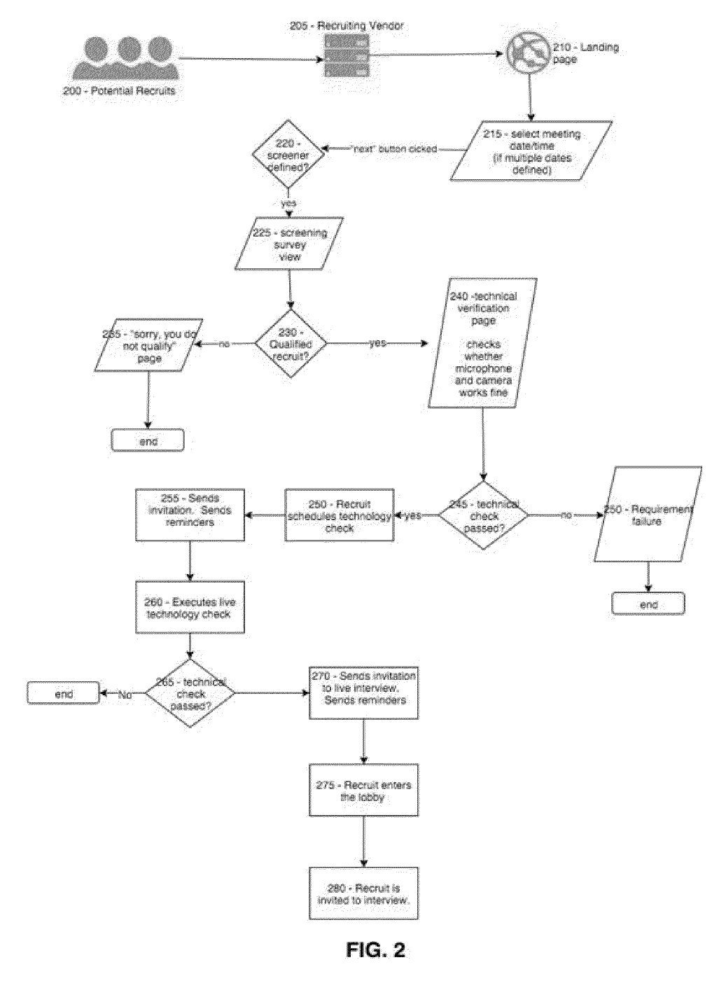

FIG. 2 illustrates a process according to an embodiment of the invention. The process of FIG. 2 may be implementable in an electronic interface to recruit human subjects for a marketing research data collection and analysis of qualitative market research data. The process of FIG. 2 is illustrated as a set of operations shown as discrete blocks. The process of FIG. 2 may be implemented in any suitable hardware (such as, e.g., server 730 and/or computer system 760), software, and/or human capital or combination thereof. The order in which the operations are described is not to be necessarily construed as a limitation.

Block 200 represents potential human-subject recruits.

Block 205 represents recruiting vendors. The administrator may select vendors from which to request recruits. This block takes attributes defined by the end user in an order for sample. The administrator applies business rules for requesting sample recruits. The administrator maintains the status of total recruits. The administrator pauses and stops recruitment once quotas have been achieved. Application may be localized to the recruit's local language.

Block 210 represents the entrance page to the screening process. The page explains to the recruit what the recruit is going to do. The interface explains what the reward will be for completion. Application is localized to the recruit's local language.

Block 215 represents an interface that allows potential recruits to select from interview time slots that they may qualify for. Application is localized to the recruit's local language.

Block 225 encompasses a section that presents the screening survey if a survey has been defined in block 220. The potential recruit is presented the questions that have been defined as part of the survey. The recruit may be presented all of the questions. The recruit can submit the survey data within the application. Application is localized to the recruit's local language.

At block 230, the application scores the recruit's answers based on an answer key.

At block 235, Recruits that don't qualify for the final interview in block 230 are informed that they did not pass the screening question. An embodiment records information about the recruit's computer IP address to block a given IP for that study for a period of time. This functionality is intended to deter people from taking the same survey over and over again to figure out how to successfully qualify.

Block 240 represents an automated technical verification test. This functionality tests to verify that the recruit's device meets the technical capabilities to participate. This includes, but is not limited to, bandwidth tests, websockets tests, browser test, and audio/video tests. Application is localized to the recruit's local language.

Block 245 represents a decision variable if the recruit passes the screening survey.

At block 250 the recruit is prompted to schedule a tech check. This is a required step to verify that the recruit's device is working with the administrator's technology. The recruit is presented with a calendar of available time slots to choose from. The list of available timeslots is dynamically populated based upon the timeslot availability calendar of administrator staff. Application is localized to the recruit's local language.

At block 255, the application sends the recruit a communication to confirm the appointment. The communication can include a link to click for the tech check interview. Communication is localized to the recruit's local language.

At block 260, the recruit participates in the tech check (aka prescreening interview). The application is localized to the recruit's local language. Real time translation is available within the text chatting component. This enables English speakers to diagnose technical problems with people in other languages. The administrator's support staff is able to push help content to the recruit in their native language.

Block 265 represents a decision variable if the recruit passes the prescreening survey.

At block 270, the administrator's application sends the recruit communication to confirm the appointment. The communication can include a link to click for the tech check interview. Communication is localized to the recruit's local language.

At block 275, the recruit clicks on the link at the time of the interview. The link takes the recruit to the lobby. At this time, the recruit doesn't detect/see anything in the lobby. The administrator moderator can detect/see all the people in the lobby. The moderator/client may select any recruit detectable/present in the lobby.

At block 280, the administrator moderator selects available recruits from the lobby to enter the virtual meeting room to conduct the interview.

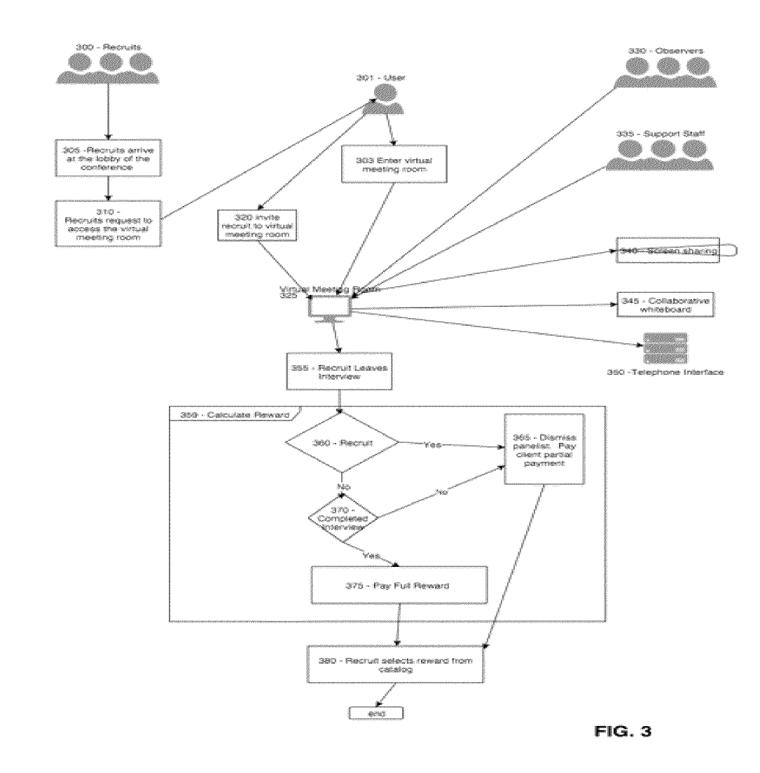

FIG. 3 illustrates a process according to an embodiment of the invention. The process of FIG. 3 may be implementable in an electronic interface to recruit human subjects for a marketing research data collection and analysis of qualitative market research data. The process of FIG. 3 is illustrated as a set of operations shown as discrete blocks. The process of FIG. 3 may be implemented in any suitable hardware (such as, e.g., server 730 and/or computer system 760), software, and/or human capital or combination thereof. The order in which the operations are described is not to be necessarily construed as a limitation.

Block 300 represents potential recruits.

Block 301 represents the administrator moderators/users.

At block 303 the user enters the virtual meeting room by clicking on their link. Security measures ensure that authentication is verified.

At block 305 the recruits click on a provided link that directs them to the lobby of the waiting room. A user interface associated with the lobby describes what they can expect to happen. Video games or the like may be provided to entertain the recruit while they wait.

At block 310 recruits alert the moderator/user that they are available to be interviewed.

At block 320, the user/moderator invites the recruit into the virtual meeting room.

Block 325 represents the virtual meeting room. Standard features include multiple-party video conferencing. The user/moderator has full control over the functionality within block 325. They have the ability to control audio and video for all participants in the interview.

Block 330 represents observers. Observers are participants who are watching the interview but don't participate directly in dialogue between the user and recruits. Observers' audio and video are disabled by default. Observers can communicate with the user/moderator using an instant messaging (IM) utility that the recruits are unable to see.

Block 335 represents support staff. Support staff can oversee and enter/access the virtual meeting room as needed.

Block 340 represents the ability of meeting participants to share their device screen with other participants.

Block 345 represents the ability of meeting participants to upload files within the meeting room. Uploaded files may be shared with all participants. All participants can annotate uploaded video assets. These annotations can be shared with all participants.

Block 350 represents the meeting room's telephony service built into the administrator application. The telephone audio is bridged to the same audio channel so that all participants can communicate with each other regardless of whether they are using internet audio or traditional telephone.

At block 355 the recruit leaves the interview.

Block 359 represents a mechanism for calculating the reward to be given to the recruited participant. If the recruit was dismissed by the client prior to completing the interview (block 360) or if the recruit voluntarily left (block 370) the recruit earns a partial reward that is calculated by the system.

Block 365 represents a mechanism for granting participants partial rewards. These rewards can be redeemed for financial rewards including gift cards and cash. These rewards may be presented as a catalog.

Block 375 represents a mechanism for granting participants full rewards.

At block 380 Recruit rewards can be redeemed for financial rewards including gift cards and cash. These rewards are presented as a catalog.

FIG. 4 illustrates a process according to an embodiment of the invention. The process of FIG. 4 may be implementable in an electronic interface to recruit consumers. The process of FIG. 4 is illustrated as a set of operations shown as discrete blocks. The process of FIG. 4 may be implemented in any suitable hardware (such as, e.g., server 730 and/or computer system 760), software, and/or human capital or combination thereof. The order in which the operations are described is not to be necessarily construed as a limitation.

At block 405, the recipient client creates a targeted consumer profile.

At block 420, the client submits demographic data for a targeted consumer profile. The embodiment captures attributes such as gender, age range, ethnicity, income etc.

At block 425, the administrator system communicates with product suppliers (users) to calculate the feasibility of finding the recruit fitting the targeted profile. Feasibility is calculated using an aggregate estimate of volume of sample along the duration of the time available and comparing it to historical recruiting data for related studies.

At block 430, the outcome of the feasibility estimate is provided to the supplier(s).

At block 431, the client creates a screening survey. The survey is designed to filter potential recruits.

At block 435, the client adds a screening criteria. This criteria may include question attributes designed to terminate potential recruits not fitting the supplier specified criteria.

At block 441, the client has the option of translating the screening survey into a different language.

At block 443, the client has the option to choose a transcription type. The type is either transcription by a human or transcription by a computer.

At block 445, if the client selects human transcription in block 443, an embodiment of the invention checks which languages are supported by the system.

At block 447, the client selects which target language into which they would like the survey translated.

At block 449, an embodiment submits the request to a transcription provider.

At block 455, the translation provider processes the translation. The embodiment monitors the translation provider for completion. Upon completion, the embodiment adds the new language to the screening survey

If the client selects machine transcription in block 443, the client is provided an interface in block 453 to select a language to translate the screening into. The text can be automatically updated upon selecting the language. The client has the ability to override the text strings upon request.

At block 415, the client is presented with a scheduling interface. The interface provides the ability to schedule interviews described in block 460. The interface includes a list of scheduled interviews. The interface provides details pertinent to the pending interview including, but not limited to, demographic data and screening survey response data.

At block 460, the client schedules a future session. The interface provides the ability to define parameters for the pending sessions.

At block 462, the interface includes the ability to define if the client is requesting automated recruiting.

If the client selects automated recruiting in block 462 the embodiment manages recruitment for the interview. Automated recruitment finds people based on the provided requirements. It queries remote databases of potential recruits. It initiates the recruiting process described in FIG. 2

At block 468, the interface provides information regarding the recruiting status.

At block 470, the interface provides the ability to invite potential recruits. This is done using a list of potential recruits that the supplier provides. Client submits an email address with the submission. The system messages consumers. The embodiment maintains state of the message and display if the message has been responded to or read.

FIG. 5 illustrates a process according to an embodiment of the invention. The process of FIG. 5 is illustrated as a set of operations shown as discrete blocks. The process of FIG. 5 may be implemented in any suitable hardware (such as, e.g., server 730 and/or computer system 760), software, and/or human capital or combination thereof. The order in which the operations are described is not to be necessarily construed as a limitation.

Block 500 indicates a researcher. An embodiment may only be available via a self-service delivery model.

Block 501 represents a Video archive interface for viewing video that has been captured by an embodiment. The video is synchronized to a time stamped transcript. Suppliers can search the transcript using a keyword.

The interface supports the creation of clips. Suppliers can select video selection—by text or video range. This selected range of video is copied as an individual video file. This video file is available to be downloaded. A security mechanism is available to “lock” and “unlock” the link to the video asset.

At block 505, a user may create any number of clips.

Block 510 represents an interface for sequencing clips together. The unique sequences can be concatenated to form new videos assets.

At block 515, the newly created assets may be downloaded within the web browser.

From the foregoing, it will be appreciated that specific embodiments of the personalized feed system have been described herein for purposes of illustration, but that various modifications may be made without deviating from the spirit and scope of the invention. Accordingly, the invention is not limited except as by the appended claims.

1. At least one computer-readable medium on which are stored instructions that, when executed by a processing device, enables the processing device to perform a method comprising the steps of:
receiving from a product supplier a consumer profile comprising preferred criteria;
identifying recruits fitting the profile;
establishing a virtual meeting space for electronic communication with said recruits;
receiving from the supplier a set of questions;
receiving from the recruits via the meeting space a set of answers to the questions; and
supplying the answer set to the supplier.

2. The medium of claim 1, wherein the method further comprises granting to the recruits a reward quantity corresponding to their quantity of participation in providing the answer set.

3. The medium of claim 1, wherein the method further comprises providing a one-way communication link over a network from the virtual meeting space to at least one virtual observation space.

4. The medium of claim 1, wherein:
a first recruit accesses the virtual meeting space using a first computing device having a first corresponding internet protocol (IP) address, and
the method further comprises blocking, for a predetermined period of time and in response to determining that the first recruit provided an undesired answer to a question of the set of questions, access to the virtual meeting space by the first IP address.

5. The medium of claim 4, wherein the method further comprises verifying over a network that the first computing device meets a predetermined set of technical capabilities to access the virtual meeting space.

6. The medium of claim 1, wherein the method further comprises establishing a virtual lobby space that enables a moderator to electronically communicate over a network with each of said recruits, said virtual lobby space preventing the recruits from communicating over the network with each other.

7. The medium of claim 1, wherein the method further comprises:
uploading video files to recruits accessing the virtual the meeting room;
enabling each recruit to annotate the uploaded video files; and
enabling each recruit to share with other recruits the annotated video files.

8. A computer-implemented method, comprising the steps of:
receiving from a product supplier a consumer profile comprising preferred criteria;
identifying recruits fitting the profile;
establishing a virtual meeting space for electronic communication with said recruits;
receiving from the supplier a set of questions;
receiving from the recruits via the meeting space a set of answers to the questions; and
supplying the answer set to the supplier.

9. The medium of claim 8, wherein the method further comprises granting to the recruits a reward quantity corresponding to their quantity of participation in providing the answer set.

10. The medium of claim 8, wherein the method further comprises providing a one-way communication link over a network from the virtual meeting space to at least one virtual observation space.

11. The medium of claim 8, wherein:
a first recruit accesses the virtual meeting space using a first computing device having a first corresponding internet protocol (IP) address, and
the method further comprises blocking, for a predetermined period of time and in response to determining that the first recruit provided an undesired answer to a question of the set of questions, access to the virtual meeting space by the first IP address.

12. The medium of claim 11, wherein the method further comprises verifying over a network that the first computing device meets a predetermined set of technical capabilities to access the virtual meeting space.

13. The medium of claim 8, wherein the method further comprises establishing a virtual lobby space that enables a moderator to electronically communicate over a network with each of said recruits, said virtual lobby space preventing the recruits from communicating over the network with each other.

14. The medium of claim 8, wherein the method further comprises:
uploading video files to recruits accessing the virtual the meeting room;
enabling each recruit to annotate the uploaded video files; and
enabling each recruit to share with other recruits the annotated video files.
